(19) United States
(12) Patent Application Publication
(10) Pub. No.: US 2009/0070324 A1
(43) Pub. Date: Mar. 12, 2009

(54) RELATED INFORMATION TRANSMISSION METHOD, RELATED INFORMATION TRANSMISSION SERVER, TERMINAL APPARATUS AND RELATED INFORMATION TRANSMISSION SYSTEM

(75) Inventor: Tatsuo YOSHINO, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/205,369

(22) Filed: Sep. 5, 2008

(30) Foreign Application Priority Data
Sep. 7, 2007 (JP) 2007-233200

(51) Int. Cl. G06F 7/06; G06F 17/30

(52) U.S. Cl. 707/5; 707/E17.014

(57) ABSTRACT

A related information transmitting method, comprising the steps of:
recording, to a database, related information corresponding to desired content and one or more desired elements in the desired content;
transmitting, from a terminal apparatus which has received the desired content, specifying information identifying the desired content and a specific element in the desired content;
extracting, from the database, related information corresponding to the identified content and the identified specific element in the content, based on the specifying information received from the terminal apparatus; and
transmitting the related information extracted from the database to the terminal apparatus.

### BACKGROUND OF THE INVENTION

1. Field of the Invention

The present invention relates to the delivery of information corresponding to a variety of content.

2. Description of the Related Art

There is a demand for technology which allows information to be obtained interactively from content delivered by broadcasting or on-demand. In the case of moving pictures having content which changes from one moment to the next, a viewer who wishes to obtain information instantaneously does not have enough time to take notes and is forced to the use the basic method of recording the moving images and looking back over the recording.

In terrestrial digital broadcasting, data is transmitted together with the video images. However, the information is poorly integrated with the Internet, and it is difficult to provide links the information in the data of the data broadcast. By converting from Broadcast Markup Language (a page description language based on XML, hereinafter abbreviated to BML) format to HTML format, it is possible to obtain a certain level of information linking. However, the complex language makes it difficult to synchronize the data with moving pictures. It is particularly difficult to transmit information linked to the changing scenes of moving pictures.

To help with this, technology known as a clickable video map (Patent Document 1) has been developed to allow the viewer to obtain necessary information by clicking on the areas of the screen in which he has an interest as he watches the moving picture. Data for hot spots, which are areas of the screen related with content-related information, are supplied with the moving images, and when the viewer clicks on one of the hotspots, he obtains the related information (URL). The link information is embedded in a multimedia defining language such as SMIL (Synchronized Multimedia Integration Language). According to this method, the viewer can obtain the information related with the clicked areas.

According to Japanese Patent Application Laid-Open No. 2004-274350, in an image delivery system, an appended information selection device supplies a specified clickable video map to a user terminal apparatus together with image content supplied from an image delivery server in response to an image delivery request. The user terminal apparatus displays the images. Then, when a clickable video map ID included in the clickable video map is selected using the user terminal apparatus, the ID is supplied as an information delivery request to a web server. The appended information selection device then selects an HTML file by comparing the supplied ID with IDs included in an appended information table, and transmits the selected HTML file. The user apparatus displays the transmitted HTML file.

According to Japanese Patent Application Laid-Open No. 2005-286882, an advertisement system includes: an advertisement server for delivering moving pictures including target object information; a terminal for receiving the moving pictures from the advertisement server and allowing a viewer to view the moving pictures; and a database server having target object information stored in a memory. For a target object of interest seen in the moving pictures on the terminal, the viewer performs a predetermined on-screen operation. The database server includes devices for extracting target object information indicated using the terminal, searching for the target object information in the memory, and communicating product information from a provider of the target object information to the terminal. Thus, the terminal is used to access the product information and sales information from the provider of the target object information during playback of the moving pictures.

### SUMMARY OF THE INVENTION

In the case of the clickable video map, click area information defined together with moving picture content is transmitted. Thus, once the moving pictures have been distributed, it is not possible to make changes such as changes to the link information or to the click areas, making it impossible to deliver information in which the viewer expresses an interest and to maintain up-to-date information.

In Japanese Patent Application Laid-Open No. 2004-274350, the image delivery system is improved by separating the image delivery server and the information delivery server so that the content of web pages on the information delivery server can be freely replaced. However, because an SMIL file is delivered together with the images, it is not possible to change the areas corresponding to the link information after delivery of the images.

Moreover, because complex instructions are carried in the data stream, it is difficult to control detailed information link destinations to match changing scenes in the moving picture.

The present invention provides an arrangement which allows a user to specify particular positions or portions in content and access information linked to content on the specified screen, while continuing to watch or listen to the content being played back.

The related information transmission method of the present invention includes the steps of: recording, to a database, related information corresponding to desired content and one or more desired elements in the desired content; transmitting, from a terminal apparatus which has received the desired content, specifying information identifying the desired content and a specific element in the desired content; extracting, from the database, related information corresponding to the content and identified specific element in the content, based on the specifying information received from the terminal apparatus; and transmitting the related information extracted from the database to the terminal apparatus.

According to the present invention, when the user specifies a specific element in the desired content using the terminal apparatus, the related information (such a URL of a web page, tag information or computer interfacing information) corresponding to the specific element in the content is extracted from the data base. The related information is then transmitted to the terminal apparatus. The user accesses the web-site or the like corresponding to the specific element in the desired content based on the returned related information, and is able to obtain useful information relating to the element of interest which appearing in the viewed content.

Both the element of the content and the related information to be corresponded with the element of the content and recorded in the database may be freely selected. Since the related information is not directly dependent on the displayed content in the manner of the clickable map, the related information can be freely corresponded with any element of the content by simply changing data in the database. Moreover, changing the data in the database is easy.

Also, the related information does not have to be recorded before the content is provided or the viewed, but may be recorded when specific information arrives. For instance, once the users of the terminal apparatus have viewed the content, their interests can be analyzed and related information provided according to those interests.

The desired content may include at least one of still picture content, moving picture content and audio content, and the one or more elements in the desired content include at least one of a region in the still picture content, a region in a frame of the moving picture content, a playback position in the moving picture content, and a playback position in the audio content.

The desired content may include at least one of content identification information uniquely identifying the desired content and storing location identification information for uniquely identifying a storage location storing related information corresponding to the elements of the desired content, and at least one of playback position identification information identifying a playback position in at least one of frames of the moving picture content and audio in the audio content, frame identification information identifying frames in the moving picture content, and coordinate identification information identifying coordinates of one or more regions in one or more frames of the moving picture content.

The specifying information may include: at least one of content identification information and storage location identification information from the desired content, and, one of specific playback position identification information identifying a playback position of a freely specified element in one of the moving picture content and the still picture content, specific frame identification information identifying a freely specified frame in the moving picture content, and specific coordinate identification information identifying coordinates of a specific region in a freely specified frame in the moving picture content.

The playback position may be recorded using a standard time code parameter in a predetermined compression coding method for moving picture content and audio content.

The content may be provided to the terminal apparatus using at least one of a cable, a wireless broadcast, Internet distribution, and a recording medium.

The wireless broadcast may include broadcast distribution to the terminal apparatus, the Internet distribution may include multicast distribution, unicast distribution, and peer-to-peer distribution to the terminal apparatus, and the recording medium may include portable media containing content that is readable by the terminal apparatus.

The related information transmission server of the present invention includes a receiving device which receives specifying information identifying desired content and a specific element in the desired content; a database which stores related information corresponding to the desired content and one or more desired specific elements in the desired content; an extracting device which extracts, from the database, related information corresponding to desired content and the specific element in the desired content identified based on the specifying information received by the receiving device; and a transmitting device which transmits the related information extracted from the database by the extracting device.

The terminal apparatus of the present invention includes an input device configured to receive input of content; a playback device configured to playback the content inputted to the input device; a specifying device configured to receive an operation to specify desired content and a specific element in the content when the playback device is playing back the content; a specifying information creating device configured to create specifying information identifying the desired content and the specific element in the content which have been specified using the specifying device; and a transmitting device configured to transmit the specifying information created by the specifying information creating device.

The transmission device may transmit the specifying information to the above-described related information transmitting server.

The related information transmission system of the present invention includes a database configured to record related information corresponding to desired content and one or more elements in the desired content; a first transmitting device configured to transmit, from a terminal apparatus which has received content, specifying information identifying desired content and a specific element in the desired content; and an extracting device configured to extract, from the database, related information corresponding to the desired content and the specific element in the desired content identified based on the specifying information received from the terminal apparatus; and a second transmitting device which transmits the related information extracted from the database to the terminal apparatus.

According to the present invention, when the user specifies a specific element in the desired content using the terminal apparatus, the related information (such a URL of a web page, tag information or computer interfacing information) corresponding to the specific element in the content is extracted from the data base and transmitted to the terminal apparatus. The user accesses the web-site or the like corresponding to the specific element in the desired content based on the returned related information, and obtains useful information relating to the element of interest which appeared in the viewed content.

Both elements of the content and the related information to be corresponded with the elements and recorded in the database may be freely selected. Since the related information is not directly dependent on the displayed content in the manner of the conventional clickable map, the related information can be freely corresponded with any element of the content by simply changing data in the database. Moreover, changing the data in the database is easy.

Also, the related information does not have to be recorded before the content is provided or the viewed, but may be recorded when specific information arrives. For instance, once the users of the terminal apparatus have viewed the content, their interests can be analyzed, and related information provided according to those interests.

### BRIEF DESCRIPTION OF THE DRAWINGS

FIG. 1 is a diagram showing a schematic construction of a related information transmitting system;

FIG. 2 is a block diagram showing a content distributing side and a receiving side (user terminal) according to a first embodiment;

FIG. 3 is a schematic showing the structure of an ES, PES and TS;

FIG. 4 is a diagram showing an example of the related information;

FIG. 5 is a diagram showing an example of a browsing target menu screen;

FIG. 6 is diagram showing an example of a case in which the tag information is embedded in Return_info_No1;

FIG. 7 is a diagram showing an example of a tag search target menu screen;

FIG. 8 is a schematic showing a layer structure;

FIG. 9 is a block diagram showing a content distributing side and a receiving side (user terminal) according to a second embodiment;

FIG. 10 is a block diagram showing a content distributing side and a receiving side (user terminal) according to a third embodiment;

FIG. 11 is a block diagram showing a content distributing side and a receiving side (user terminal) according to a fourth embodiment;

FIG. 12 is a block diagram showing a content distributing side and a receiving side (user terminal) according to a fifth embodiment;

FIGS. 13A to 13C are diagrams showing an example of moving picture content and related information;

FIG. 14 is a diagram showing an example of a timing for setting the related information;

FIG. 15 is a diagram showing an example of a timing for setting the related information;

FIG. 16 is a diagram showing a schematic construction of a related information managing system which employs a peer-to-peer method; and

FIG. 17 is a diagram showing a schematic construction of a related information managing system including a plurality of content information managing servers.

### DETAILED DESCRIPTION OF THE PREFERRED EMBODIMENTS

The following describes the preferred embodiments of the present invention with reference to the accompanying drawings.

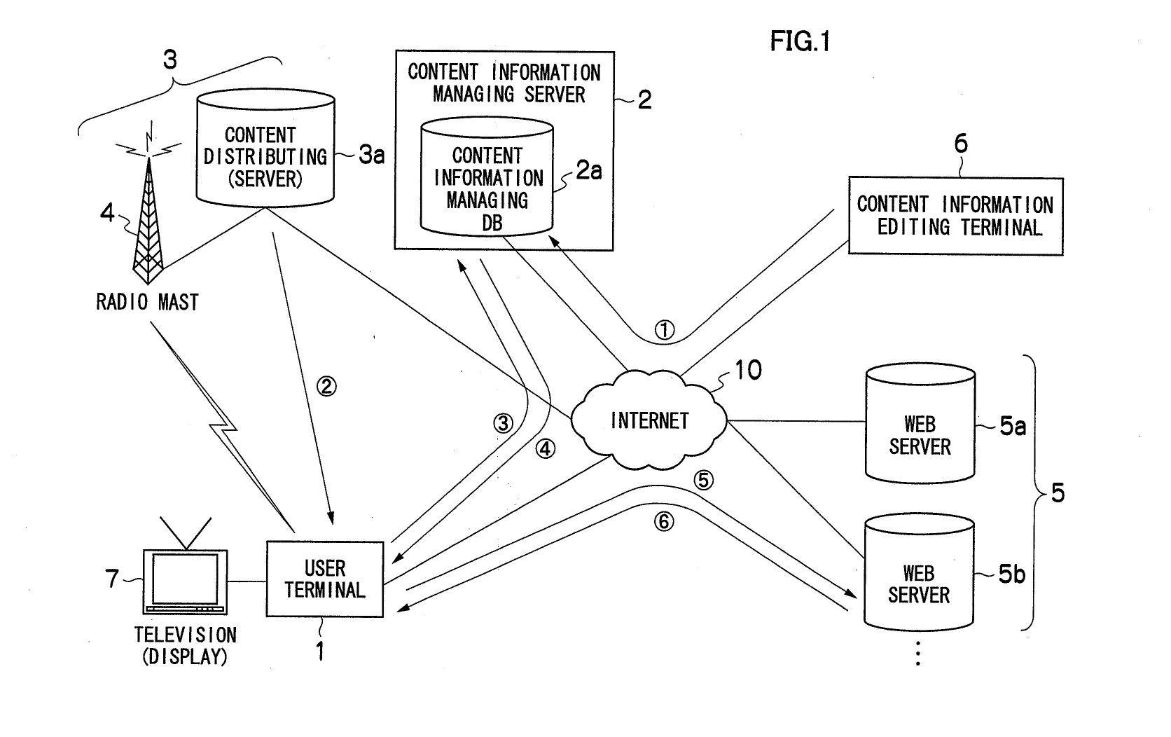

FIG. 1 shows a schematic construction of a related information management system according to a preferred embodiment of the present invention. The system includes a user terminal 1 and a content information managing server 2.

The user terminal 1 may receive a variety of content including images (still and moving pictures) as direct electrical signals from a distribution side 3 such as a content distributing server 3a, a radio mast 4 of a television station or the like. Alternatively, the user terminal 1 may receive the same content by reading recorded signals corresponding to content from a recording medium such a DVD. The user terminal 1 is also connected to an unspecified number of web servers 5 (5a, 5b etc.) via the Internet 10.

The content information managing server 2 is connected to a content information editing terminal 6 via the Internet 10.

The user terminal 1 is an apparatus which supports multimedia recording and playback, such as a Personal Computer (PC) or Set Top Box (STB), and allows delivered content to be outputted and displayed on a television 7 when the content includes images. The user terminal 1 also allows delivered content to be outputted and played back on a stereo or the like when the delivered content is audio.

According to the present embodiment, it is assumed that the present invention is applied to a separate STB so that an existing television or stereo can be used. However, the present invention may also be applied to televisions, stereos and other AV devices having built-in functions equivalent to those of the STB of the present embodiment.

The method by which the content is distributed from the distribution side 3 to the user terminal 1 is not limited in any particular way: Examples of possible distribution methods include broadcast distribution using terrestrial digital broadcasts, satellite broadcasts, multicasting using Internet TV, and unicasting using VOD (video on demand), streaming or the like. Another possibility is dispersed distribution by which content is distributed between peers over the Internet 10 rather than being delivered directly from the content distributing server, as in peer to peer movie distribution systems. A further possibility is to provide the content using portable recording media such as DVDs and the like.

The content information managing server 2 includes a content information managing DB 2a. Content-related information (hereinafter abbreviated to related information) matched to the distributed content is created using the content information editing terminal 6, uploaded to the content information managing DB 2a, and stored thereon.

The related information is corresponded with content titles, and information in desired scenes and nearby portions in the content.

The content distribution data includes information specifying content titles and element identification information for identifying specific elements (scenes and nearby portions in a moving picture) in the content. The element identification information may, for instance, include frame information, and time information. The element identification information may be used to encapsulate or subband the content distribution data.

The user terminal 1 receives input of desired elements in the content as a result of operations on a mouse or other pointing device as the received content is played back. For instance, if the content is being played back on a television 7, the operation may specify a specific position in a specific frame in the still or moving picture, or a specific word announced at a specific time in the audio playback.

The user terminal 1 creates element identification information corresponding to the element specified by the user in the specifying operation and transmits the created element identification information to a content information managing server 2.

More specifically, the user terminal 1 extracts an ID of the content being played and element identification information (such as specific moving picture frame information, in-frame position information, or time information indicating a specific audio playback position) from the content distribution data, and uses the extracted information as specifying information. The user terminal 1 then creates transmission data for transmission to the content information managing server 2 by forming packets or the like, and transmits the transmission data to the content information managing server 2 over the Internet 10.

The content information managing server 2 analyzes the specifying information transmitted from the user terminal 1, and searches the content information managing DB 2a for related information corresponding to the element (scene, position or the like) of the content specified by the position information or time information. Note that the content to be searched is itself specified by the ID included in the specifying information.

The related information stored in the content information managing DB 2a so as to correspond to the specifying information can be corresponded with any position of any scene in the content.

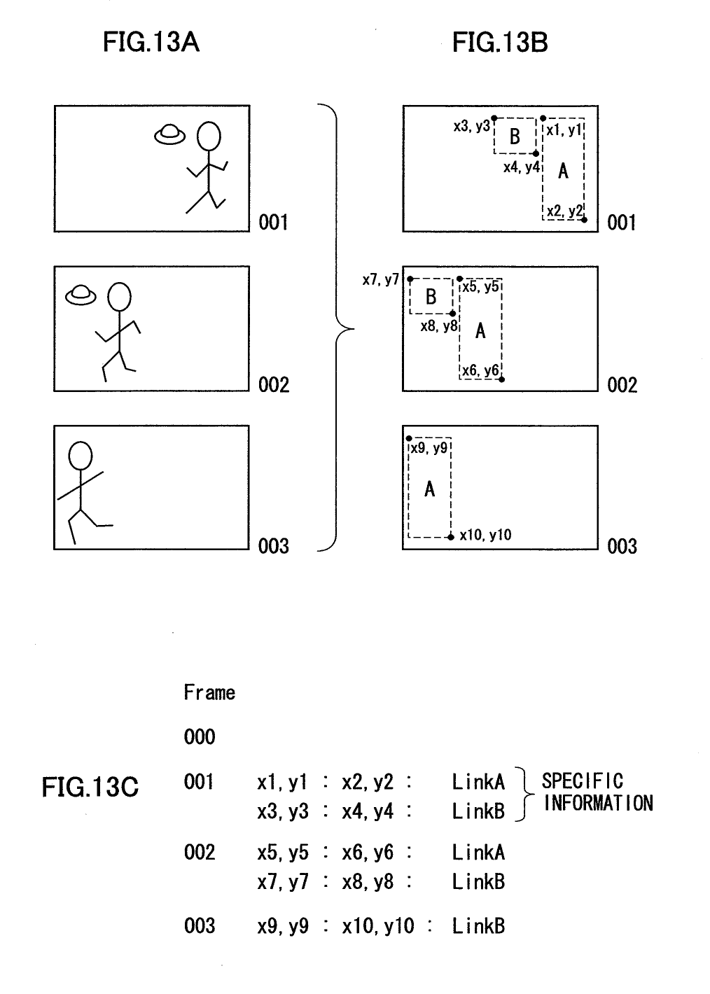

For example, in the television program or the like shown in FIG. 13A, the content element “area A” of the right-hand side as shown in FIG. 13(B) and the content element “area B” in the center of frame “001” in the moving picture may be selectable. A variety of related information can be set for each element. Specifically, the content element “area A” of frame “001” is set as the rectangular area defined by x1,y1 and x2,y2 and the content element “area B” is set as the rectangular area defined by x3,y3 and x4,y4, and the corresponding related information is set for each element.

In frame “002” of the moving picture, the central content element “area A” and the left-hand content element “area B” are selectable. Thus, the content element “area A” of frame “002” is set as the rectangular area defined by x5,y5 and x6,y6 and the content element “area B” is set as the rectangular area defined by x7,y7 and x8,y8, so that the corresponding related information can be specified.

In frame “003”, the content element “area A” is selectable. Thus, the content element “area A” is set as the rectangular area defined by x9,y9 and x10,y10 and the content element “area B” is set as the rectangular area defined by x1,y1 and x2,y2, so that the corresponding related information can be specified.

By defining independently moving content element areas in the frames so as to allow corresponding related information to be specified, content elements and related information can be freely corresponded.

FIG. 13C shows an example of related information which has been corresponded with the content elements “area A” and “area B” of the frames shown in FIG. 13B. The content element “area A” has been corresponded to the related information “Link A” and the content element “area B” has been corresponded with the related information “Link B”. Any content element can be corresponded with any related information. Moreover, the content of the related information can be freely selected. In summary, the present inventions offers a high degree of freedom in the setting of the related information and excellent maintainability in comparison to the conventional clickable map model according to which the related information is directly dependent on the content elements.

Note that it is possible to correspond the same related information to different elements in the content. For instance, when a program from a sponsor A is distributed, the URL of a website 5a containing advertising information from the sponsor A can be returned to the user terminal 1 irrespective of the scene and position clicked by the user. Alternatively, separate related information can be provided to viewers with different interests by recording, for the same display area in the same scene, a plurality of related information made up of advertising information from a plurality of sponsors.

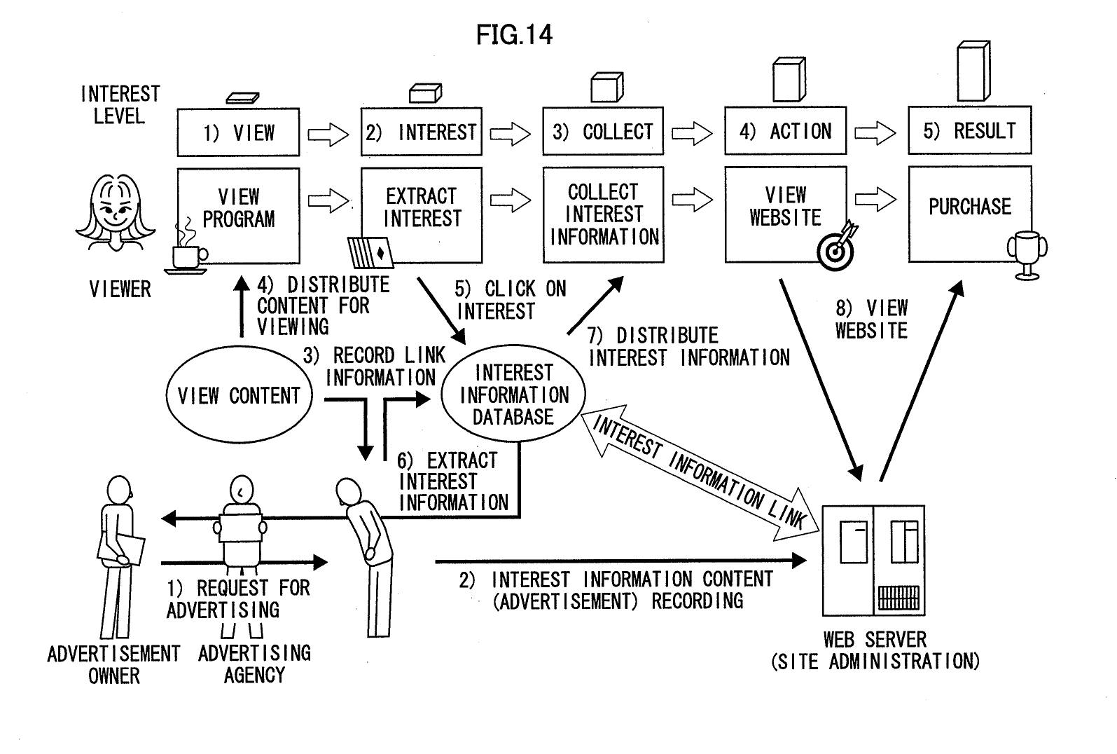

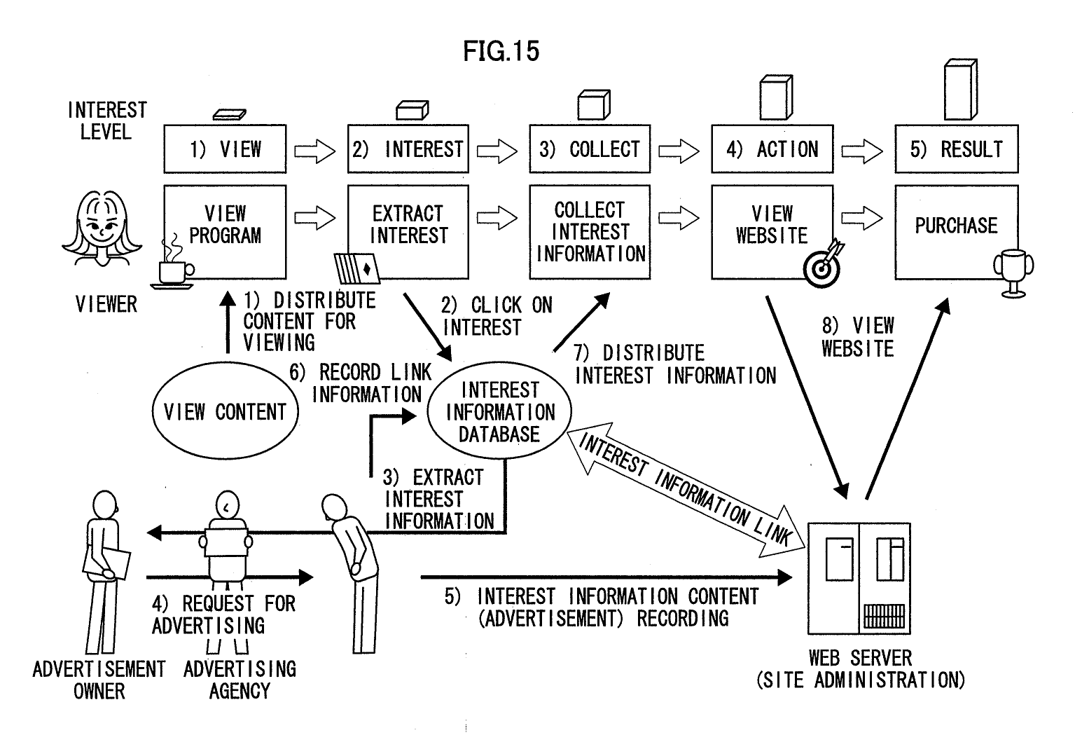

Moreover, the related information may be set and stored in the content information managing DB 2a before the content is viewed using the user terminal 1 (as shown in FIG. 14) or based on an analysis of user interest carried out after the content is viewed (FIG. 15).

When related information matching the element identification information received from the user terminal 1 exists in the content information managing DB 2a, the content information managing server 2 finds and returns the related information to the user terminal 1 which sent the specifying information. When the content information managing DB 2a does not hold related information corresponding to the specifying information received from the user terminal 1, the administrator of the web server 5 may be notified so that relevant related information can be added.

The related information includes information (such as a URL, hereinafter referred to as access target information) necessary for accessing a server 5 which is the access target, image data for a button showing the access target or for another GUI, and deletion date data indicating the date on which the related information is to be deleted from the content information managing server 2. Using the deletion date data, it is possible to set an information provision period in the content information managing server 2, and thereby control period over which information is provided to the user.

As the content is playing, the user terminal 1 receives the related information sent from the content information managing server 2, arranges the related information, and, in accordance with a browsing operation by the viewer, displays on the television 7 access target information buttons based on the received related information.

If the access target information display button is specified by a user operation, the received related information is converted to a button menu and displayed on the television 7. When the user selects and presses a button of interest from the button menu, the user terminal 1 accesses the web server 5 corresponding to the pressed button.

The web server 5 then returns web content to the user terminal 1. The user terminal 1 displays the web content. According to this arrangement, the user is able to browse the web content which has been corresponded to the element of interest (e.g. scene, playback point, or frame image) in the delivered content.

### First Embodiment

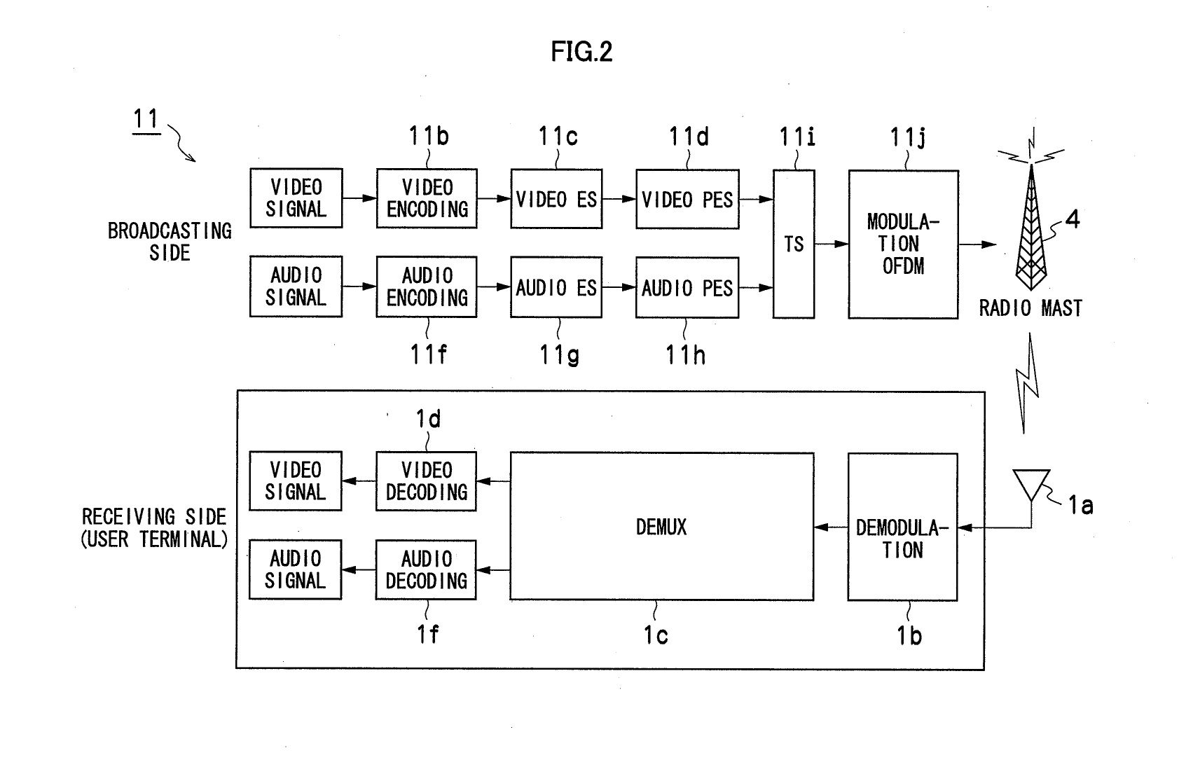

FIG. 2 is a diagram showing an example construction in which the distribution side 3 broadcasts moving picture content.

The distribution system 11 which is an example of the distribution side 3 includes a video encoding unit 11b, a video ES unit 11c, a video PES unit 11d, an audio encoding unit 11f, an audio ES unit 11g, an audio PES unit 11h, a TS unit 11i and an OFDM modulation unit 11j.

The video encoding unit 11b performs digital compression coding on an externally inputted video signal.

The video ES unit 11c converts the compressed digital video signal to an ES (Elementary Stream).

The video PES unit 11d creates a packetized elementary stream (hereinafter abbreviated to PES) from the ES.

The audio encoding unit 11f performs digital compression coding on an externally inputted audio signal.

The audio ES unit 11g converts the compressed digital audio signal to an ES (Elementary Stream).

The audio PES unit 11h creates a packetized elementary stream (hereinafter abbreviated to PES) from the ES.

The TS unit 11i generates transports stream packets each having a payload holding the video/audio PES and a packet identifier which depends on the type of information held in the payload.

The OFDM modulation unit 11j time-expands the transport stream and performs OFDM (Orthogonal Frequency Division Multiplexing) modulation. Thereafter, the modulated streams are transmitted using radio waves via a radio mast 4.

The user terminal 1 on the reception side includes an antenna 1a, a demodulation unit 1b, a DEMUX (demultiplexer) 1c, a video decoding unit 1d and an audio decoding unit 1f.

The antenna 1a receives the radio waves from the radio mast 4, and outputs to the demodulation unit 1b. The demodulation unit 1b recovers the TS from the radio waves, and outputs the TS to the DEMUX 1c. The DEMUX 1c separates the TS into video data and audio data, outputs the video data to the video decoding unit 1d and the audio data to the audio decoding unit 1f.

The video decoding unit 1d decodes the video data to recover the video signal. The audio decoding unit 1f decodes the audio data to recover the audio signal.

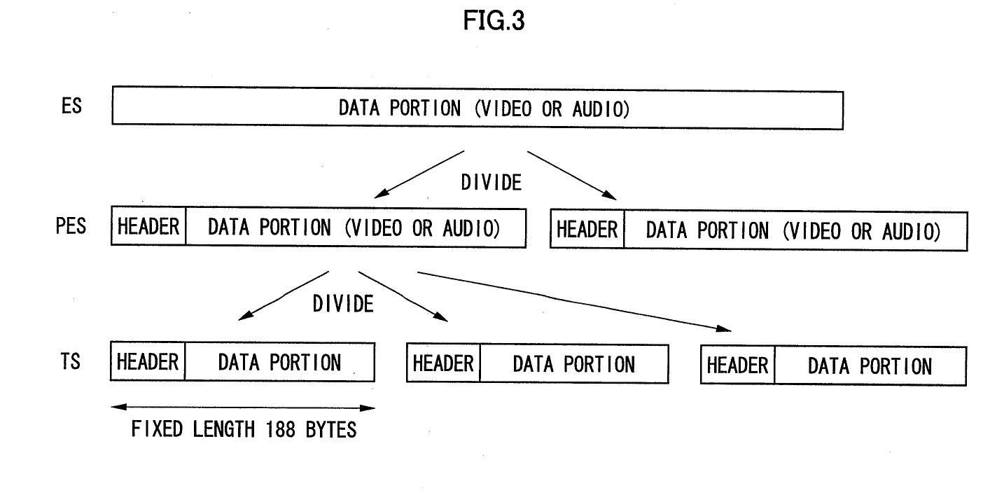

As shown in FIG. 3, the video and audio signals are compression encoded to form data streams of a predetermined format by the video encoding unit 11b and the audio encoding unit 11f. The encoded data streams are converted to the video ES and the audio ES, which are generally streams of video data and audio data in frame units, by the video ES unit 11c and the audio ES unit 11g. Next, the video PES 11d and the audio PES 11h divide the data appropriately, attaching a header to the front of each piece of data to form packetized video PES and audio PES. Note that the synchronization of the video and audio at playback is achieved by including time information in the PES header information.

The PES data stream is divided into sections of fixed length. The TS unit 11i attaches a TS header to the front of each section to generate TS packets having a fixed length of 188 bytes. Although not shown in the drawings, at the TS conversion stage the audio and video may be multiplexed with SI (Service Information) such a broadcast-use data (BML: Broadcast Markup Language) and program information, and PI (Program Specific Information) that records which program each ES in the TS belongs to. Although the above-described PES conversion and multiplexing are performed according to the MPEG 2 format, other formats may be used.

Before the OFDM modulation in the OFDM modulation unit 11j a check bit of a 16-byte Reed-Solomon code is attached to the TS packets to improve resistance to random errors.

Then, so that both fixed receiver and mobile receiver services can be supported, a series of OFDM modulation processes are performed. The processes are hierarchical division (up to a maximum of 3 systems), convolutional coding, carrier modulation, hierarchical composition, time/frequency interleaving, OFDM frame construction, IFFT, and addition of guard intervals. The modulated signal is then outputted from the radio mast 4.

In the user terminal 1 on the receiving side, the radio waves received by the antenna 1a are tuned. The demodulation unit 1b then performs a series of demodulation processes, and the DEMUX 1c separates the encoded video signal and the encoded audio signal. The data signal is separated in the same way.

The encoded video signals and the encoded audio signals are then decoded using the video decoding unit 1d and the audio decoding unit 1f to recover a synchronous video signal and audio signal which can be played back.

The content-specifying information, such as ID information zzz, and the frame number (1, 2, 3, . . . ) and time information (hh:mm:ss:zz) of each frame of the moving picture are embedded together to allow acquisition during playback on the playback side. It is then possible, for instance, to trigger acquisition of the content ID information and information specifying a scene when the viewer is viewing the scene.

Scenes can be specified by embedding information specifying the content and the information specifying the scene in the video stream data in advance, and acquiring these pieces of information at playback.

Systems which make use of the MPEG 2 format, for instance, have time code parameters. Thus, by embedding a time code at distribution, and reading the time code at playback, it is possible to realize frame specification even in widely used video streaming standard. Note, however, that when recording programs to DVDs, the time code parameter may be undesirably overwritten by a recorder. Thus, when the recorded data is played back, problems may be caused by the information managed by the content information managing server 2. Hence the time code parameter should only be used for frame specification in programs which cannot be recorded.

The ID information specifying the content may acquire information about the selected channels and viewing times on the user terminal 1 side, and the content information managing server 2 side may use the information to find content IDs stored in an electronic program guide (EPG) from the information.

Next, the user terminal 1 displays a pointer cursor on the screen of the television 7 which is playing back the content, and acquires an address (a0, b0) indicating a specific position on the screen. In other words, the viewer performs an operation on the screen to specify a portion of interest in the content being viewed, and the specified position becomes address (a0, b0).

The extracted information is recorded as text data or the like in a form such as “click_info (Contents ID=zzzz, frame No=ffff, address=a0,b0)”. Information identifying the specific element of interest to the viewer in the content is transmitted to the content information managing server 2 by sending message information using the SIP (Session Initiation Protocol) to the content information managing server 2.

The employed protocol does not have to be SIP. However, when exchanging information over an unspecified period between a large number of user terminals 1 and the content information managing server 2, the use of SIP allows the exchanges to take place without maintaining constant connections between all of the user terminals 1 and the server 2. Thus, with SIP, the load on the system is small.

The content information managing server 2 specifies an Internet address of the user terminal 1 on the Internet 10 based on the SIP packets transmitted from the user terminal 1, extracts the text message information included in the SIP packets, and queries the content information managing DB 2a about the information (click_info).

The content information managing DB 2a extracts the related information based the query. Specifically, the content information managing DB 2a searches the database tables, which are stored for each content ID, for the frame number (e.g. frame No=002) recorded in the click_information transmitted from user terminal 1. For example, the content information managing DB 2a may judge from the database table shown in FIG. 13C whether a click point (e.g. a1, b1) falls in the regions corresponded with the frame 002 (i.e. the two rectangles defined by x1, y1, x2, y2 and x3, y3, x4, y4), and, when judging in the affirmative, extracts the related information associated with the specific information (e.g. Link A).

The above describes an example of related information transmission in which messages are exchanged using the SIP protocol. However the transmission method is not limited to this. For instance, if an email address is included when the specifying information extracted on the user terminal 1 side is transmitted from the user terminal 1 side to the content information managing server 2 side, the related information extracted from the content information managing DB 2a can be transmitted to the email address in email format. With this arrangement, the related information can be used in terminals (such as mobile telephones and mobile devices) other than the terminal which sent the specifying information.

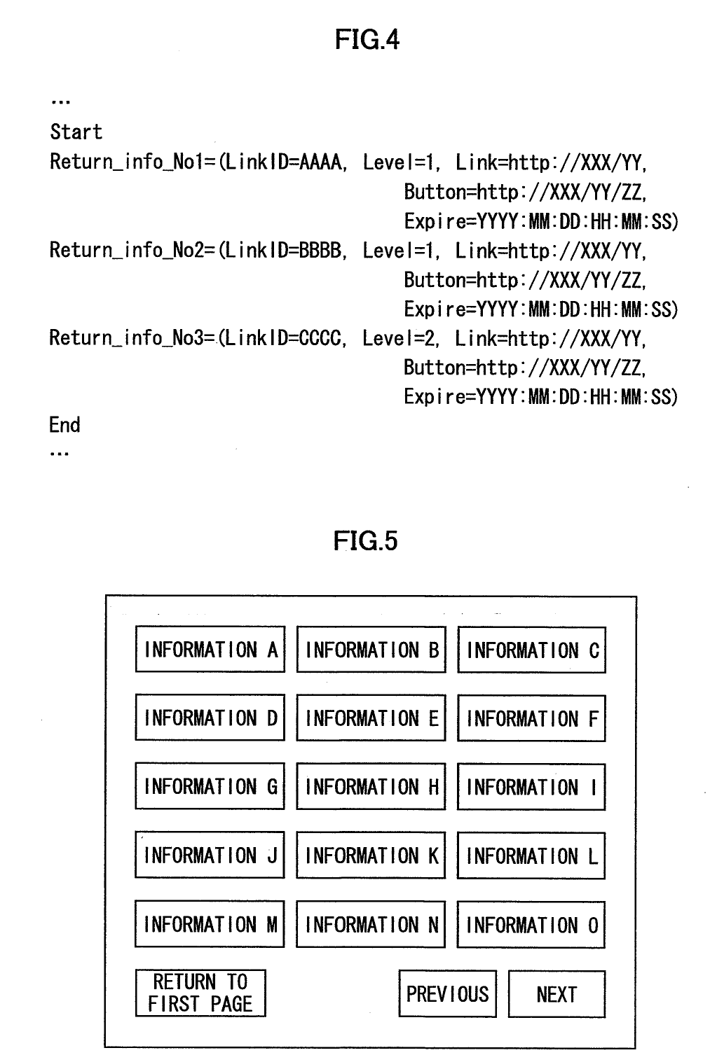

FIG. 4 shows an example of the related information. In this case, the content information managing DB 2a extracts three pieces of related information based on a specific element (position) in the specified scene clicked on the user terminal 1 side.

The content information managing DB 2a may include a plurality of access target information in response to a single piece of query information. For instance, the related information which is extracted may be links to information about an object clicked in a given scene, and link information for a product in a clicked scene in an advertisement during a given program, link information for the sponsor of the program. Further, when a single point is clicked, the related information may provide a link to the object at the point, or related information from a predetermined range (e.g. including scenes before and after the clicked scene).

The Link ID is an ID which identifies the access target information. When repeated clicks have been made and the same information has been returned a number of times, the Link ID can be used to avoid the same information being displayed more than once on the terminal user terminal 1 side.

The Level is set is based on an estimated level of importance to the viewer. When an object heavily dependent on the scene is clicked, the Level is set based after estimating the level of importance to the viewer of the region associated with the object. For instance, the Level may be set to 3 over an entire program.

Thus, with this arrangement, the display of the user terminal 1 for the viewer is controlled according to the level of priority assigned to the information to be displayed.

The Button indicates the address of the server where image data for the banner button to be displayed on the user terminal 1 of the viewer is stored. Data, such as image data, which places even a small load on the content information managing server 2 can be split off and stored, for instance, on the web server 5 of the sponsor. With such an arrangement, the sponsor can change the data freely, and the load on the content information managing server 2 is reduced.

The user terminal 1 automatically records returned access target information in an access target information management table and downloads banner button image data from the web server 5 or the content information managing server 2.

Expire indicates a valid lifetime for the related information, and may be used to ensure that the related information is deleted from the user terminal 1 before the corresponding content is deleted from the web server 5 managed by the sponsor. Note that although the Expire times are the same in the drawings, each Expire time can be set independently.

A payment system may be used in which the advertising fee charged to the sponsor is determined according to the size (storage area size or timewise length) of the related information stored in the content information managing DB 2a from the storage time of the related information in the user terminal 1. An alternative is a payment system in which payment is awarded according the actual number of buttons clicked by the viewer on the user terminal 1.

The user terminal 1 reads the SIP messages returned from the content information managing server 2, performs analysis to check for repetition, and stores the viewer-interest related information in a access target information management table not shown in the drawings. The user terminal 1 then downloads the banner button image data, prepares the banner button image data for display on the display screen of the user terminal 1, and links the button to the access target information.

Thus, if the viewer performs an operation using an “information browse button” on the user terminal 1 after viewing the program or at another time, the user terminal 1 displays a browsing target menu screen containing a summary of the potentially desirable information which has been stored in the access target information management table. The information is displayed in a predetermined order.

When, for example, an “Information A” button (i.e. the banner image button for information A) is selected on the browsing target menu shown in FIG. 5, the user terminal 1 connects to a specific web server 5 (e.g. the web server 5a), which is the access target corresponding to the information A button. The user terminal 1 is thereby linked the specific web server 5 and able to display information that is related to the information A and of interest to the viewer.

In the example shown in FIG. 5, the browsing target menu screen provided to the user terminal 1 from the web server 5 has multiple pages, and allows the viewer to move between pages using the “NEXT”, “PREVIOUS” and “RETURN TO FIRST PAGE”.

The user terminal 1 periodically checks the valid lifetime of the access target buttons, and deletes any buttons which have exceed the Expire period. The access target buttons may also be deleted by operations by the viewer.

In the present system, the banner button image and access target content linked to the banner button can be changed freely by the owner of the advertisement or the like based on the specification of the system.

When the viewer presses the banner button, the user terminal 1 may upload the information corresponding to the banner to the content information managing server 2 or to another server. The information is counted as browsing result information which records operations by the viewer, and may be used as parameter information for a results-based fee to the owner of the advertisement.

In the above-described example, URL information for the access target was returned directly. However, the related information from the content information managing DB 2a may include tag information (e.g. a product name, or object attribute definition), computer interfacing information (e.g. service interface parameters), and other information defining the access target.

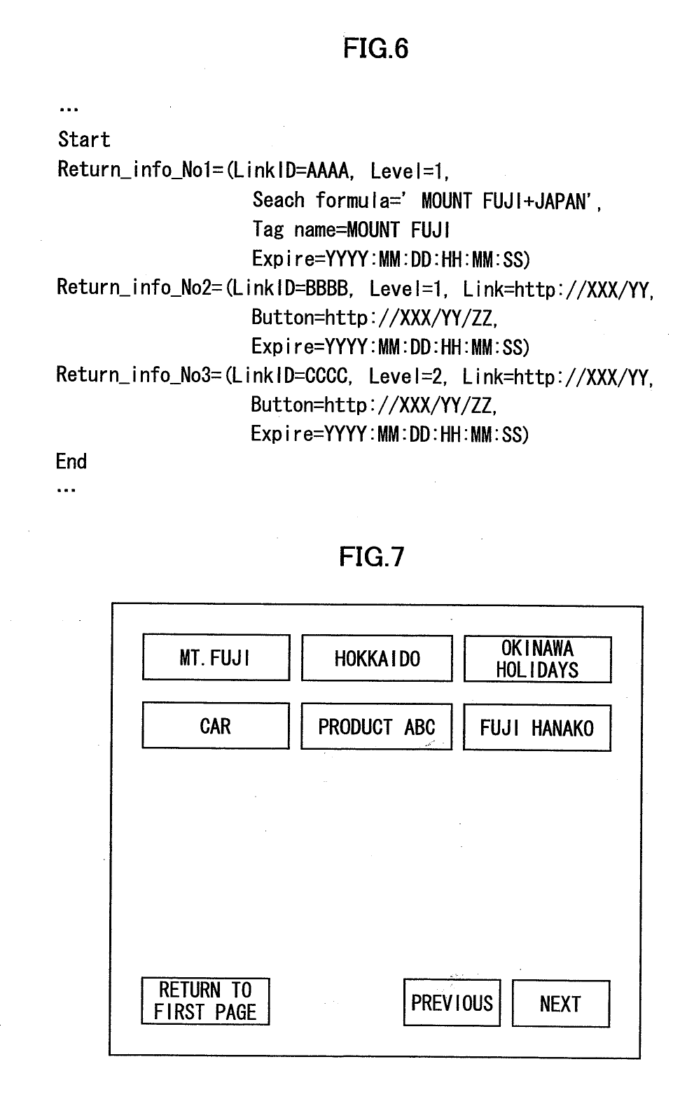

FIG. 6 shows an example in which tag information is embedded in Return_info_No1. Thus, when the viewer performs an operation using a “browse tag information” button (not shown) on the user terminal 1 after viewing the program or at some other time, a tag search target menu screen is displayed. The tag search target menu screen displays, in a predetermined order, a summary of the potentially desirable tag information stored in the access target information management table.

When, for example, an “Mt. Fuji” button is selected on the tag search target menu shown in FIG. 7, the user terminal 1 connects to a server (not shown) equipped with a search engine robot, inputs “Mt. Fuji+Japan” in a defined search format, and begins a search.

Note that the owners of advertisements can attract viewers to their own websites by defining the search method in advance so that viewer is likely to arrive at the company website.

The following describes an example of a method for embedding scene specific information in the content.

Well-known examples of moving picture codecs include MPEG-2, M-PEG-4 and H.264 which employ hierarchical structures.

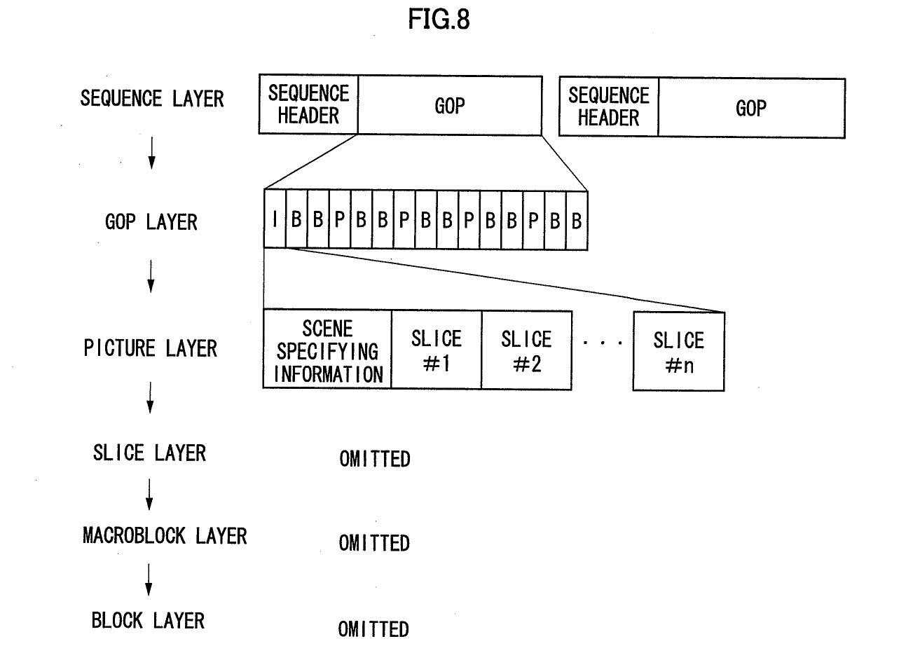

As shown in FIG. 8, hierarchy is made up of a sequence layer, a GOP layer, a picture layer, and lower layers.

The sequence layer is a sequential stream of video including GOPs and header information. The header information includes information about the video data including an image size, an aspect ratio and a frame rate. The GOP is made up of groups of frames. By embedding the content ID for specifying the content in the header information, it is possible to realize switching between content with comparatively short units (of approximately 0.5 seconds).

For example, by allocating the program a content ID of xxxx and allocating the advertisements positioned part-way through the program content IDs of yyyy and zzzz, it is possible to define the various content in the scenes during playback. Since a content ID corresponding to the video content is embedded in the content every 0.5 seconds, content identifying information can be indicated in a comparatively short time.

In this case, when returning from the advertisements to the program, the content ID returns to xxxx, and the scene information (such as the frame numbers) begins from the continuation point in the program.

It is possible to treat the program and the advertisements as a single piece of content. However, separating the program and the advertisement to form separate pieces of content allows the scene information of an advertisement to be treated as the same piece of content, even when the advertisement is included in different programs. This is advantageous when storing the access target information in the content information managing server 2, which is described in a later section.

The GOP layer is made up of I frames, P frames and B frames. I frames are frames with low compression ratios capable of being played back as single frames. P frames are obtained from differences between the predicted motion of I frames and I frames. B frames are predicted frames coded after the I frames and P frames so as to interpolate between past and future frames. The data stream is generally made up of GOP (Group of Pictures), each of which normally contains 15 frames represented by [IBBPBBPBBPBBPBB].

The picture layer includes frame units corresponding the I frames, P frames, and B frames from the GOP. Each frame unit can be treated as a single still picture.

The picture layer is made up of slice-like image units each of which corresponds to a strip on the screen. Aligning the slices constructs a single screen.

The content ID data may be embedded in the user expansion data of the sequence header, and the element identification information may be embedded in the user expansion data of the picture header.

The lower layers are a 16×16 macroblock layer and an 8×8 block layer which are defined below the picture layer.

Thus, when encoding the content, a content ID specifying the content is inserted in each GOP unit and a frame number (or time information) specifying frames including scenes of interest may be inserted in each frame.

The scene identification information (element identification information) may be inserted in only I frame for the purposes of simplification. In this case, the resolution of the element identification information will deteriorate to approximately 0.5 seconds. However, since the viewer performs operations while viewing the video images, a shorter specification time is unnecessary.

By calculating the frame numbers or time information of frames between the I frames on the decoding side, it is possible to reduce the specification time to 1/30 seconds.

Thus, when the element identification information has been included in a moving picture codec and the resulting data stream has undergone modulation, the information can be recovered after the demodulation and decoding stage.

Note that when it is not possible to insert the content ID and the scene identification information (element identification information) into a live broadcast or previously recorded video, the time information in the broadcast can be used in place of the content ID and the scene identification information.

### Second Embodiment

The following describes an example of video distribution in which a video distributing server on the Internet 10 transmits video to a receiving client.

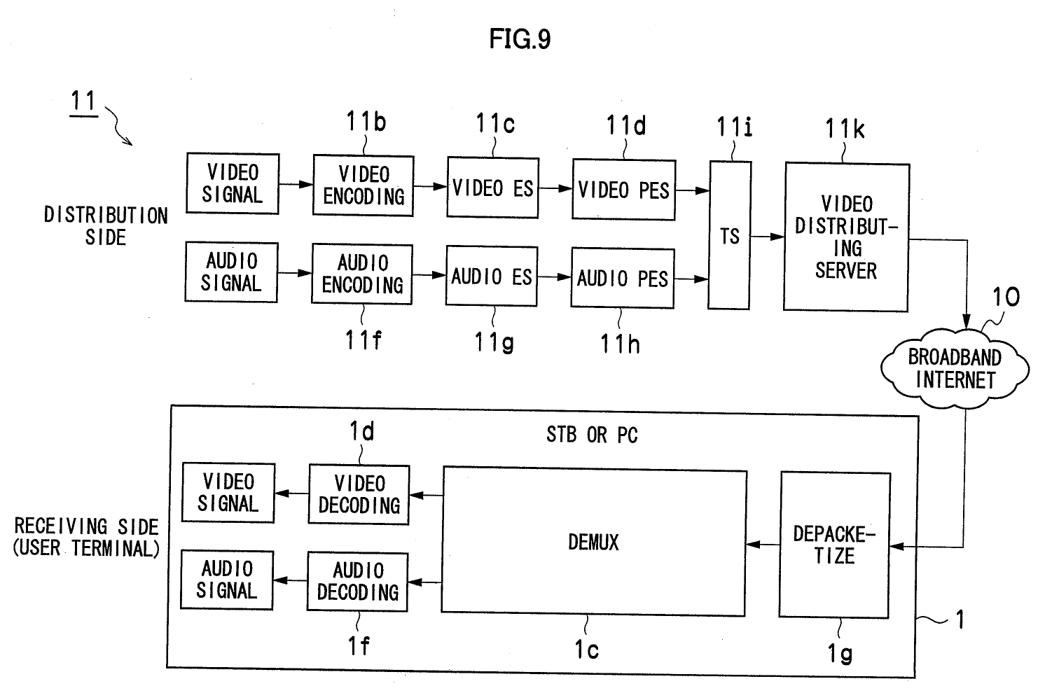

As shown in FIG. 9, a distribution system 11 performs predetermined processing on audio and video content using a video encoding unit 11b and an audio encoding unit 11f performs TS filling in the TS unit 11i, and places the content as a steaming file in place in the video distributing server 11k.

In multicasting, the video distributing server 11k the video distributing server 11k performs TS file conversion, and stores the result in a predetermined location in a video distributing server for user terminals 1 on the reception side which have requested distribution at a distribution time as a streaming file.

In unicasting, the video distributing server 11k transmits requested content in response to individual requests from the user terminals 1. In the case of unicasting, the content on the video distributing server 11k is generally encrypted for copyright protection so that only verified user terminals play back the content.

The content in the IP packets used to allow from the video distributing server 11k over the Internet 10 are then depacketized to recover the TS streaming data from which the Codec data is recovered using the DEMUX 1c.

Hence, with this arrangement, it is possible to embed content identification information and scene identification information (element identification information) at the processing stage in the video encoding unit 11b and to extract the content identification information and scene identification information at the processing stage in the video decoding unit 1d during playback, in the same way as in the first embodiment.

In unicasting, when a bidirectional transmission configuration such as RTSP (Real Time Streaming Protocol) is used between the video distributing server 11k and the user terminal 1 on the receiving side, content identification information and element identification information are embedded in the moving picture Codec when the playback point is changed on the server side by the user terminal 1 side using a fast-forward or rewind operation. It is therefore possible to extract the identification information from the playback frame at the playback point.

In the present example, it has been supposed thus far that the distribution system 11 makes use of streaming distribution, with the identification information being extracted from streamed data from the server. However, the data from the video distributing server 11k may be temporarily stored in the user terminal 1, as VOD (Video On Demand)-type systems. In this case too, the identification information is contained in the VOD data, and so it is possible to uniquely extract content identification information and element identification information at playback.

### Third Embodiment

The following describes another example of video distribution in which a content distributing server 3a on the Internet 10 distributes video to user terminals 1 on the receiving side. Here, it is supposed that the system supports the distribution of rich content used when viewing ordinary websites.

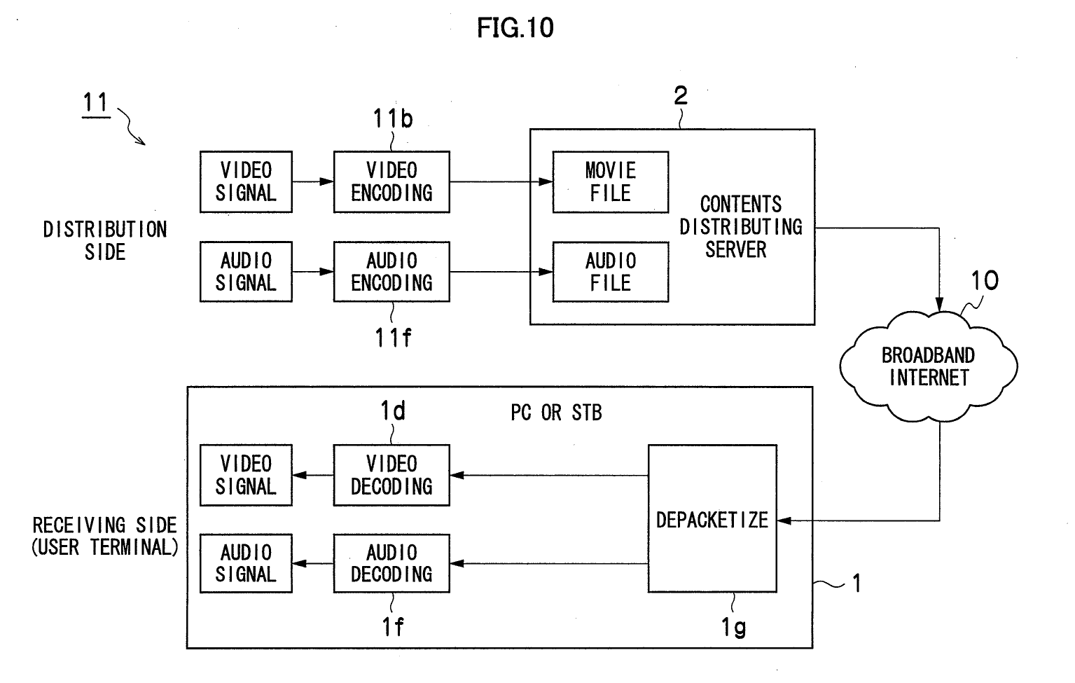

In encoding unit 11b of the distribution system 11 shown in FIG. 10, the employed Codec format is, for instance, Flash Video format (FLV format), embedded in the web page of rich contents. Note that that the blocks which are the same as those in other embodiments are marked with the same symbols.

When rich content is to be viewed on a web browser of the user terminal 1, the user terminal 1 side downloads screen constructing component data for used by the browser in accordance with screen constructing instructions recorded in HTML format. The screen construction component data includes moving picture file data which is played back. Content identification information and element identification information can be written in the moving picture file data. The user terminal 1 is then able to read the content identification information and the element identification information embedded in each frame as the moving picture file is played back.

### Fourth Embodiment

The following describes an example for application in the distribution still picture content via the Internet 10.

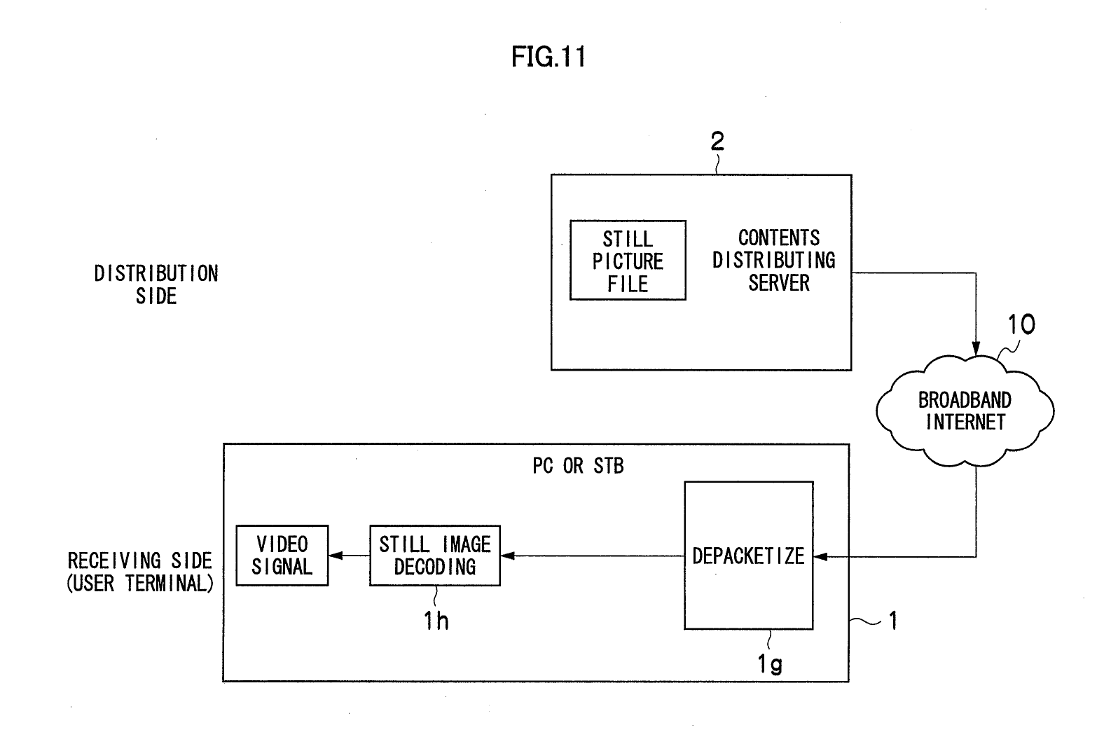

As shown in FIG. 11, the viewer uses a web browser of a personal computer or the like to view still picture content which is of interest. Hence, the content identification information and element identification information is included in the images to be viewed (still picture file). Hence, it is possible to extract the content identification information and the element identification information when the still picture content is reproduced. The content identification information and the element identification information can be embedded in the tag information of the still picture format.

The user terminal 1 of the displays images decoded using a still image decoding unit 1 and reproduced on the television 7, and displays a pointer indicating a position. The viewer can move the pointer to indicate different points on the reproduced images using a mouse or remote control GUI.

The point indicated by the pointer is used as address information for identifying positions in a scene. The arrangement is standardized so that equivalent information can be acquired as address information from any user terminal 1 irrespective of screen resolution.

When the viewer is interested in given picture, moves the pointer to a desired position in the picture and performs an indicating operation, the user terminal 1 acquires address information of the indicated position and sets the address information as the element identification information corresponding to a content element.

### Fifth Embodiment

The following describes an example in which content recorded on a recording media such as a DVD is played back.

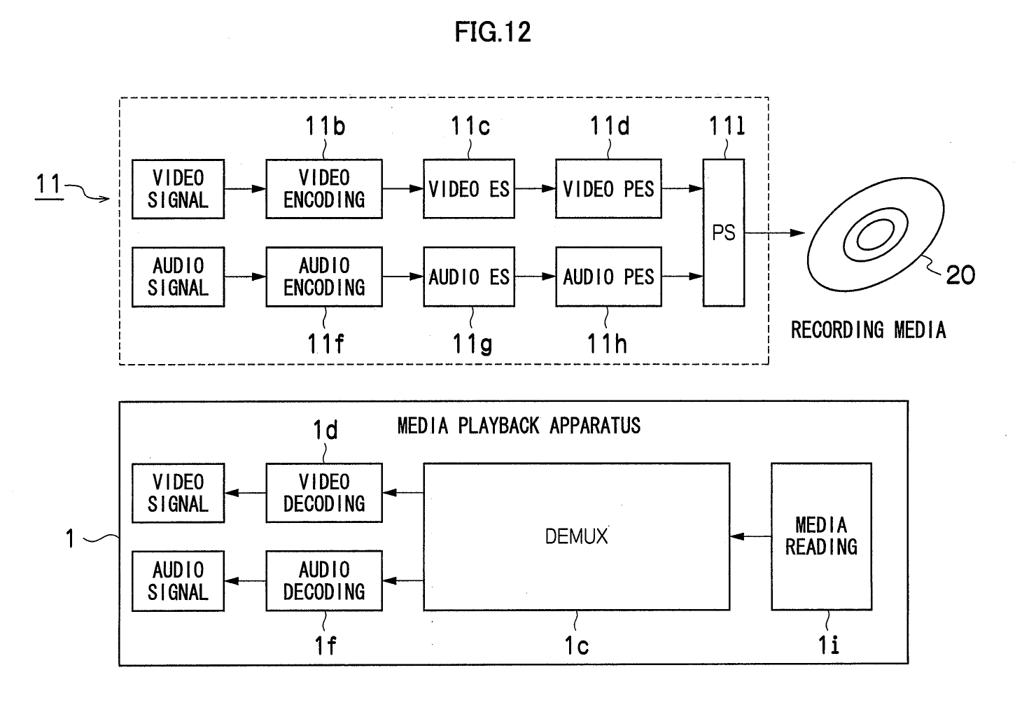

As shown in FIG. 12, a recording media production system 11 encodes the video signal and the audio signal, performs ES, conversion, PES conversion and PS (program stream) conversion, and writes the resulting data stream to recording media 20. During the encoding, the content identification information and the element identification information are written into the Codec in the same way as in the first embodiment.

When the viewer plays back the recording media using a media playback apparatus 1, the content identification information and the element identification information can be extracted in the same way as in the other embodiments.

The recording media is not limited to being a DVD. The content identification information and the element identification information can be extracted in the same way when the recording media is a hard disk drive built in to a hard disk recorder, a DVD player, a personal computer, or another media playback apparatus and HDD of a home server on the home network.

### Sixth Embodiment

If in the distribution of audio content, the content identification information and the element identification information are written into an encoded audio stream at regular intervals (of 0.5 sec) during the encoding, it is possible to acquire information identifying sounds (words) in which a listener has expressed an interest.

For example, when a listener performs a click operation on hearing the words “Mt. Fuji”, the content identification information (e.g. a radio program) and element identification information (e.g. time information at point of the click operation) are sent to the content information managing server 2. The content information managing server 2 returns related information from the content information managing DB 2a based on the query. Moreover, when a listener who is listening to music likes a song, and performs an operation during that song, information (recorded by the distributor) to allow the listener to connect to a server for downloading the song may be sent as the related information. The listener can thereby acquire the information (access information) for the download source.

### Seventh Embodiment

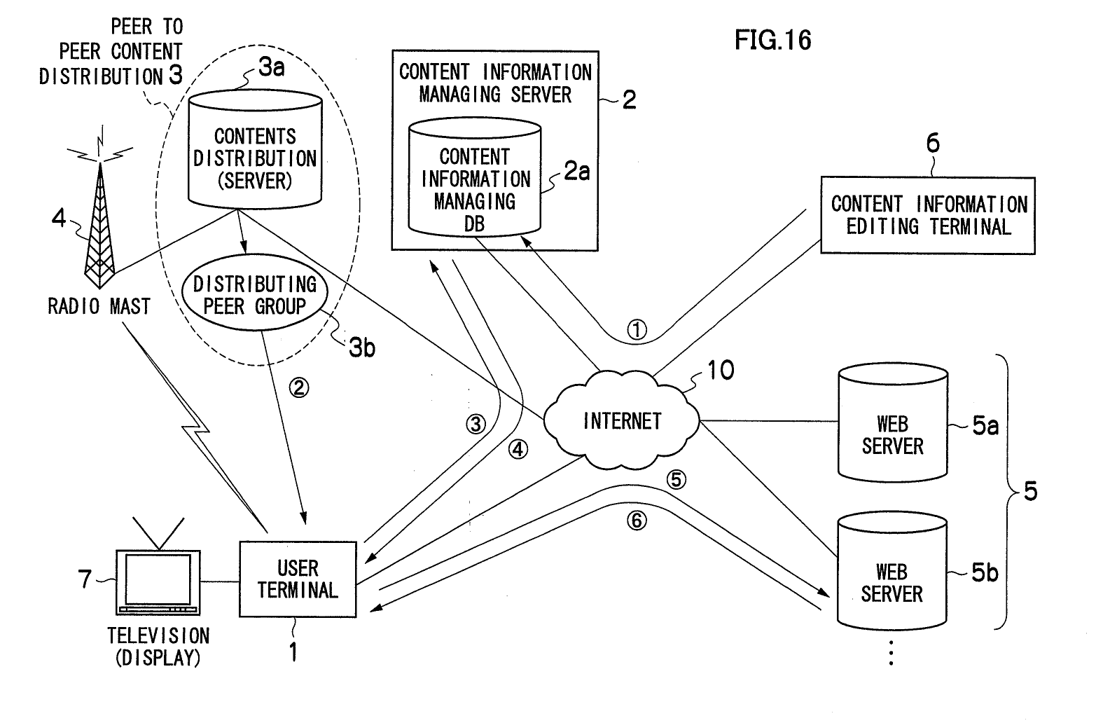

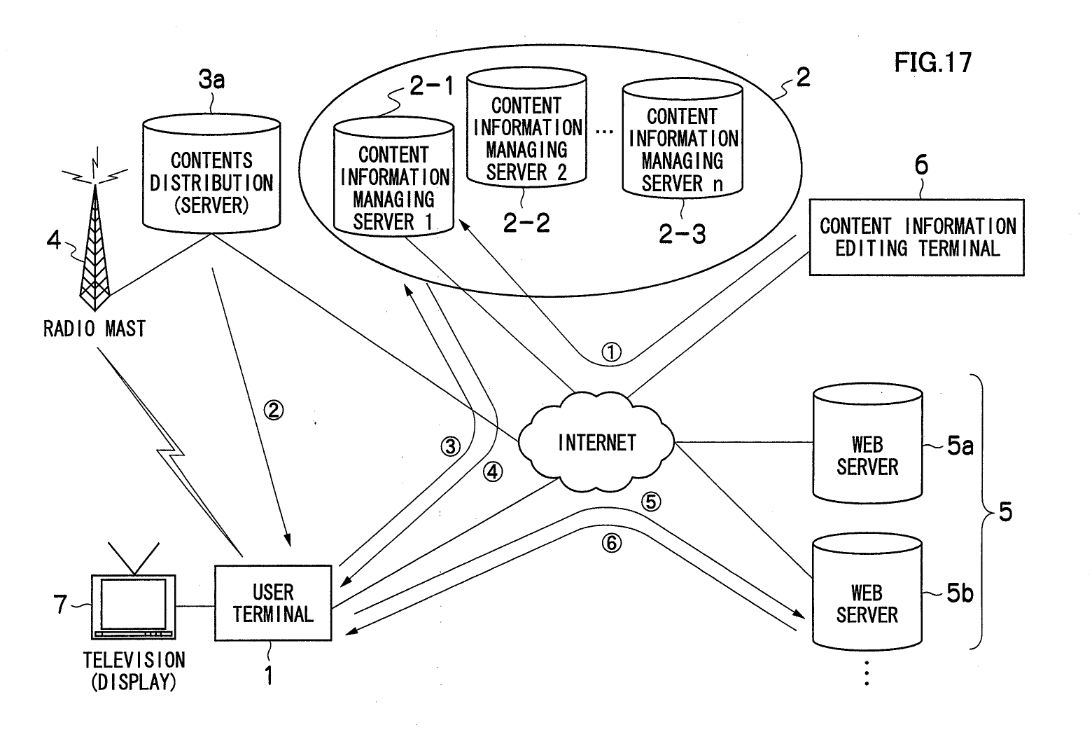

FIG. 16 is a diagram showing a schematic construction of a related information management system according to a further embodiment. The system content is distributed from the distribution side 3 to the user terminals 1 using a peer-to-peer method.

First, the content distributing server 3a performs processing (copyright protection processing) such as encryption to prevent illegitimate copying and stores the content so as to be spread among a distributing peer group 3b which includes the user terminal 1. Storing the contents so as to be spread among members of the distributing peer group 3b reduces the concentration of accesses to the content distributing server 3a.

The user terminal 1 then makes a query about content distribution sources (peer to be distributed of a peer-to-peer terminal group 3b) to the content distributing server 3a or the like, and is thereby able to specify one or more content distributing sources which are peer terminals (or the content distributing server 3a) and receive the content.

Here, the user terminal 1 may receive a single piece of content from a single peer. Alternatively, the user terminal may receive a single piece of content from a plurality of peers in order to improve the robustness of the content protection.

Thus, in the case of peer-to-peer distribution, although the content to be distributed over the Internet 10 may be encrypted and spread among many apparatuses, it is still possible to extract the content ID and time-related position information (playback point information and frame information) from the content at decoding. Hence, the content and elements of interest (e.g. specific scenes or frames) can be specified on the user terminal side.

### Eighth Embodiment

FIG. 16 is a diagram showing a schematic construction of a related information management system according to a further embodiment. The content information managing server 2 includes a group of managing servers 2-1, 2-2, 2-3, etc. Each managing server 2-n in the group of managing servers includes a different content information managing DB (not shown). Thus, the content information managing server 2 is effectively a plurality of servers rather than just one server.

In this case, the user terminal 1 has to identify which managing server 2-n of the plurality of managing servers 2 the specifying information should be sent to. Hence, in this case, information specifying one of the managing servers 2 is embedded in the content to be distributed.

For example, address information (e.g. “http://aaaa.cojp/bbb/id=zzzz”) of the managing server 2-n can be embedded in advance together with the content ID information in the above-described content. The user terminal 1 can then specify the server to configured to transmit the specifying information by extracting the address information of the managing server 2-n from the distributed content.

What is claimed is:

1. A related information transmitting method, comprising the steps of:
recording, to a database, related information corresponding to desired content and one or more desired elements in the desired content;
transmitting, from a terminal apparatus which has received the desired content, specifying information identifying the desired content and a specific element in the desired content;
extracting, from the database, related information corresponding to the identified content and the identified specific element in the content, based on the specifying information received from the terminal apparatus; and
transmitting the related information extracted from the database to the terminal apparatus.

2. The related information transmitting method according to claim 1, wherein
the desired content includes at least one of still picture content, moving picture content and audio content, and
the one or more elements in the desired content include at least one of a region in the still picture content, a region in a frame of the moving picture content, a playback position in the moving picture content, and a playback position in the audio content.

3. The related information transmitting method according to claim 2, wherein
the desired content includes:
at least one of content identification information uniquely identifying the desired content and storing location identification information for uniquely identifying a storage location storing related information corresponding to the elements of the desired content; and
at least one of playback position identification information identifying a playback position in at least one of frames of the moving picture content and audio in the audio content, frame identification information identifying frames in the moving picture content, and coordinate identification information identifying coordinates of one or more regions in one or more frames of the moving picture content.

4. The related information transmitting method according to claim 3, wherein
the specifying information includes:
at least one of content identification information and storage location identification information from the desired content; and
one of specific playback position identification information identifying a playback position of a freely specified element in one of the moving picture content and the still picture content, specific frame identification information identifying a freely specified frame in the moving picture content, and specific coordinate identification information identifying coordinates of a specific region in a freely specified frame in the moving picture content.

5. The related information transmitting method according to claim 3, wherein
the playback position is recorded using a standard time code parameter in a predetermined compression coding method for moving picture content and audio content.

6. The related information transmitting method according to claim 1, wherein
the content is provided to the terminal apparatus using at least one of a cable broadcast, a wireless broadcast, Internet distribution, and a recording medium.

7. The related information transmitting method according to claim 6, wherein
the cable broadcast and the wireless broadcast include broadcast distribution to the terminal apparatus,
the Internet distribution includes multicast distribution, unicast distribution, and peer-to-peer distribution to the terminal apparatus, and
the recording medium includes portable media containing content that is readable by the terminal apparatus.

8. A related information transmitting server, comprising:
a receiving device which receives specifying information identifying desired content and a specific element in the desired content;
a database configured to store related information corresponding to the desired content and one or more desired specific elements in the desired content;
an extracting device which extracts, from the database, related information corresponding to desired content and the specific element in the desired content identified based on the specifying information received by the receiving device; and
a transmitting device which transmits the related information extracted from the database by the extracting device.

9. The related information transmitting server according to claim 8, wherein
the desired content includes at least one of still picture content, moving picture content and audio content, and
the one or more elements in the desired content include at least one of a region in the still picture content, a region in a frame of the moving picture content, a playback position in the moving picture content, and a playback position in the audio content.

10. The related information transmitting server according to claim 9, wherein the desired content includes:
at least one of content identification information uniquely identifying the desired content and storing location identification information for uniquely identifying a storage location storing related information corresponding to the elements of the desired content; and
at least one of playback position identification information identifying a playback position in at least one of frames of the moving picture content and audio in the audio content, frame identification information identifying frames in the moving picture content, and coordinate identification information identifying coordinates of one or more regions in one or more frames of the moving picture content.

11. The related information transmitting server according to claim 10, wherein
the specifying information includes:
at least one of content identification information and storage location identification information from the desired content; and
one of specific playback position identification information identifying a playback position of a freely specified element in one of the moving picture content and the still picture content, specific frame identification information identifying a freely specified frame in the moving picture content, and specific coordinate identification information identifying coordinates of a specific region in a freely specified frame in the moving picture content.

12. The related information transmitting server according to claim 10, wherein
the playback position is recorded using a standard time code parameter in a predetermined compression coding method for moving picture content and audio content.

13. The related information transmitting server according to claim 8, wherein
the content is provided to the terminal apparatus using at least one of a cable, a wireless broadcast, Internet distribution, and a recording medium.

14. The related information transmitting server according to claim 13, wherein
the wireless broadcast includes broadcast distribution to the terminal apparatus,
the Internet distribution includes multicast distribution, unicast distribution, and peer-to-peer distribution to the terminal apparatus, and
the recording medium includes portable media containing content that is readable by the terminal apparatus.

15. A terminal apparatus, comprising:
an input device which receives input of content;
a playback device which plays back the content inputted to the input device;
a specifying device which receives an operation to specify desired content and a specific element in the content when the playback device is playing back the content;
a specifying information creating device which creates specifying information identifying the desired content and the specific element in the content which have been specified using the specifying device; and
a transmitting device which transmits the specifying information created by the specifying information creating device.

16. The terminal apparatus according to claim 15, wherein
the transmitting device transmits the specifying information to the related information transmission server according to claim 8.

17. A related information transmitting system, comprising:
a database configured to record related information corresponding to desired content and one or more elements in the desired content;
a first transmitting device which transmits, from a terminal apparatus which has received content, specifying information identifying desired content and a specific element in the desired content; and
an extracting device which extracts, from the database, related information corresponding to the desired content and the specific element in the desired content identified based on the specifying information received from the terminal apparatus; and
a second transmitting device which transmits the related information extracted from the database to the terminal apparatus.

18. The related information transmitting system according to claim 17, wherein
the desired content includes:
at least one of still picture content, moving picture content and audio content; and
the one or more elements in the desired content include at least one of a region in the still picture content, a region in a frame of the moving picture content, a playback position in the moving picture content, and a playback position in the audio content.

19. The related information transmitting system according to claim 18, wherein
the desired content includes:
at least one of content identification information uniquely identifying the desired content and storing location identification information for uniquely identifying a storage location storing related information corresponding to the elements of the desired content; and
at least one of playback position identification information identifying a playback position in at least one of frames of the moving picture content and audio in the audio content, frame identification information identifying frames in the moving picture content, and coordinate identification information identifying coordinates of one or more regions in one or more frames of the moving picture content.

20. The related information transmitting system according to claim 19, wherein
the specifying information includes:
at least one of content identification information and storage location identification information from the desired content; and
one of specific playback position identification information identifying a playback position of a freely specified element in one of the moving picture content and the still picture content, specific frame identification information identifying a freely specified frame in the moving picture content, and specific coordinate identification information identifying coordinates of a specific region in a freely specified frame in the moving picture content.

21. The related information transmitting system according to claim 19, wherein
the playback position is recorded using a standard time code parameter in a predetermined compression coding method for moving picture content and audio content.

22. The related information transmitting system according to claim 17, wherein
the content is provided to the terminal apparatus using at least one of a cable, a wireless broadcast, Internet distribution, and a recording medium.

23. The related information transmitting system according to claim 22, wherein
the wireless broadcast includes broadcast distribution to the terminal apparatus,
the Internet distribution includes multicast distribution, unicast distribution, and peer-to-peer distribution to the terminal apparatus, and the recording medium includes portable media containing content that is readable by the terminal apparatus.
